(19) United States
(12) Patent Application Publication
(10) Pub. No.: US 2006/0122350 A1
(43) Pub. Date: Jun. 8, 2006

(54) Convalently bonded polyhedral oligomeric silsesquioxane/polyimide nanocomposites and process for synthesizing the same

(75) Inventors: Kung-Hwa Wei, Hsinchu (TW); Chyi-Ming Leu, Hsinchu (TW)

Correspondence Address: JOSEPH J. ORLANDO;BUCKNAM AND ARCHER, 1077 Northern Boulevard, Roslyn, NY, 11576, US

(73) Assignee: National Chiao Tung University

(21) Appl. No.: 11/294,132

(22) Filed: Dec. 5, 2005

Related U.S. Application Data
(62) Division of application No. 10/828,435, filed on Apr. 20, 2004.

(30) Foreign Application Priority Data
Jan. 13, 2004 (TW) 093100772

(51) Int. Cl. C08G 77/04; C08G 77/455

(52) U.S. Cl. 528/25

(57) ABSTRACT

Polyhedral oligomeric silsesquioxane/polyimide nanocomposites with certain mechanical properties and low dielectric constant is synthesized by covalently tethering functionalized polyhedral oligomeric silsesquioxane molecules to polyimide. These nanocomposites appear to be self-assembled systems. A process for synthesizing said polyhedral oligomeric silsesquioxane/polyimide nanocomposites also is provided, comprising a step of forming porous type polyhedral oligomeric silsesquioxane, and a subsequent step of reacting with dianhydride or directly reacting with synthesized polyimide.

### CROSS REFERENCE TO RELATED APPLICATIONS

Priority is claimed under 35 U.S.C. 119 of Taiwanese Patent Application No. 093100772 filed Jan. 13, 2004. Priority is also claimed under 35 U.S.C. §120 of U.S. patent application Ser. No. 10/828,435 filed Apr. 20, 2004.

### BACKGROUND OF THE INVENTION

1. Field of the Invention

The present invention relates to covalently-tethered polyhedral oligomeric silsesquioxane/polyimide nanocomposites and the synthesis process thereof. Polyhedral oligomeric silsesquioxane in the composites has nanoporous inorganic architecture, polyimide has high-temperature resistance and good mechanical properties; as both are synthesized through specific process, the composites with low dielectric constant while maintaining certain mechanical properties is obtained; in the synthesis process, the polyhedral oligomeric silsesquioxane having one or multiple reactive groups, for example, amino, is used as a monomer for reacting with dihydride or is directly reacted with polyimide having complementary reactive functional groups, to form nanocomposites.

The applications of the present nanocomposites, according to the properties (for example, dielectric properties) of the materials, are not limited to the needs of traditional high-temperature insulting materials, including in industrial fields of microelectronics, aerospace technologies, semiconductor elements, nano technologies and the like; further, due to the consistent nanopore features, are expandable to some other fields, for example, the utilities in the ultra-micro filtration technologies.

2. Description of the Prior Art

In recent years, due to the miniaturization of electronic elements and increase of integral density, the quantity of conductor connection in the circuits is continuously increased, and the parasitic effect between resistances (R) and capacitances (C) in the conductor connection architecture is created, which results serious RC-delay and also becomes the primary factor to limit the signal transmission speed. D. D. Denton et al., J. Master Res., 1991, 6, 2747, B. S. Lim et al., J. Polymer Sci., Part B: Polym. Phys., 1993, 31, 545, and S. Z. Li et al., J. Polymer Sci., Part B: Polym. Phys., 1995, 33, 403, all disclose the finding of the above. Therefore, in order to effectively elevate the operating speed of the chips, it is necessary to introduce leads having low resistivity and inter-lead insulting films having low parasitic capacitance during the production processes of multilayer conductor connection. With this technical background of development, it becomes an interesting objective in this field to search for better, more reliable dielectric materials, in which polyimide is preferably used as the dielectric intermediate layer material through simple spin coat technology, since it has heat resistance (above 500° C.), chemical resistance, high mechanical strength, and high electrical resistance due to its aromatic chemical structure, high symmetry, and rigid chain structure; however, it is necessary to further reduce the not-low-enough dielectric constant (usually between 3.1 and 3.5) of the general pure polyimide, particularly for the possibility of interlacing of conductor leads after the elements and line width are constricted during the miniaturization.

One of the methods to reduce the dielectric constant of polyimide is to modify its physical or chemical architecture, for example, as disclosed in Eashoo, M. et al., J. Polym. Sci., Part B: Polym. Phys., 1997, 35, 173, which synthesizes fluorine containing polyimide materials, utilizes high electronegative fluorine elements, blends them into polyimide to reduce the polarization of electrons and ions in the films, then obtains polyimide with dielectric constant at 2.5 to 2.8; however, the mechanical strength of this fluorine containing polyimide material is largely reduced and the prices of said polymerization monomers are high, so that there are difficulties in applying this material; next, the method disclosed by Carter, K. R. et al (see related documents published by Carter, K. R. et al., for example, Adv. Mater., 1998, 10, 1049; Chem. Mater. 1997, 9, 105; 1998, 10(1), 39; 2001, 13, 213) uses a small molecular material which is cracked at specific temperature, and goes into polyimide by mixing or reacting; this small molecular material creates pores inside polyimide material when the proceeding heat treatment reaches its thermal crack temperature (i.e., about 250-300° C.). These pores reduce the dielectric constant of polyimide because the dielectric constant of air is close to 1, i.e., κ=1. These porous type materials are produced, and the dielectric constant of said materials are reduced to between 2.3 and 2.5; however, the problems associated with this technology include the difficulties to homogeneously distribute the small molecules into polyimide material and to form closed pores, to eliminate the inconsistency of the pore size, and to remove the organic residues after the crack; further, the mechanical properties of porous type polyimide are less preferable and too weak to be determined, and also the flattening effect is not good.

As to the synthesis of polyimide, the finding of polyimide began in 1908 when Bogert and Renshaw conducted intra-fusion polycondensation of intramolecules with 4-amino phthalic anhydride or dimethyl-4-aminophthalate; however, it was not further studied (refer to M. T. Bogert and R. R. Renshaw, J. Am. Chem. Sci., 1908, 30, 1135) until Dupont took out patents for aromatic polyimide in 1950, and it was commercially applied to high temperature insulting materials in 1960. The synthesis of polyimide is a typical polycondensation, as disclosed in related documents as T. L. Porter et al., J. Polymer Sci., Part B: Polym. Phys., 1998, 36, 673, and A. Okada et al., Mater. Sci. Eng., 1995, 3, 109; the producing process is divided into two stages, first diamine and dianhydride monomers are solubilized in polar solvents to form the precursor of polyimide, poly(amic acid) (PAA), and then imidization is carried out at high temperature (300˜400° C.), so that the precursor is closed-ring dehydrated into polyimide products.

### SUMMARY OF THE INVENTION

The primary object of the present invention is to provide nanocomposites, in which said composites are formed through covalent bonding of functionalized polyhedral oligomeric silsesquioxane (POSS) and polyimide; as POSS tethering nanopores connects to side chains of polyimide with covalent bonds, the pores are homogeneously distributed and the distribution amount can be adjusted, so that a certain degree of mechanical strength and a lower dielectric constant comparing to conventional polyimide are obtained. Further, a self free-standing film can be formed with said materials, i.e., said insulting film is of given mechanical strength to be peeled off from conductors and substrates without being supported by substrates while maintaining the integrity.

Another object of the present invention is to provide a process for synthesizing polyhedral oligomeric silsesquioxane/polyimide nanocomposites, in which porous type inorganic oxide oligomers are formed first and then are reacted with dianhydride, or directly through reacting with synthesized polyimide.

The inventor has completed extensive studies in order to have inorganic substances with nanopores regularly distributed inside polyimide to reduce dielectric constant without impairing mechanical strength of said polyimide. In various applications for foming organic-inorganic nanocomposites, polyhedral oligomeric silsesquioxane is easily bonded to form polymers due to having functional groups, such as single functional groups or graftable monomers, difunctional comonomers, surface modifying agents, or multifunctional crosslinking agents. For example, a member of polyhedral oligomeric silsesquioxane, octamer (RSiO_{1.5})₈, which has pores of 0.3 to 0.4 nanometer, exhibits cage shape and is composed of a central silicon atom and cube peripheral oxygen atoms; wherein R groups are capable of reacting with linear or thermosetting polymers and incorporating with some polymers, for example, acrylics, styrenics, epoxide derivatives, and polyethylenes, to have enhanced thermal stability and mechanical strength.

The inventor has proved in researches that POSS covalently tethering nanopores connects to end groups of polyimide to obtain low dielectric constant and controllable mechanical properties. However, the maximum amount of POSS in polyimide is no more than 2.5 mole %, since the amount of end groups available for tethering POSS is limited. If the dielectric constant of polyimide is to be further reduced, then it is very critical to increase the amount of covalently bonded POSS; therefore, copolymerization is implanted alternatively in the present invention to form porous films, that is, molecules tethering POSS containing defined architecture are directed onto side chains of polyimide. As the amount of side chains for tethering POSS is greater than that of end groups, the advantage of producing materials with variable dielectric constant by changing the proportion of POSS in polyimide is obtained.

Typically, the polyimide usable in the present invention has polymerization units represented by following formula: 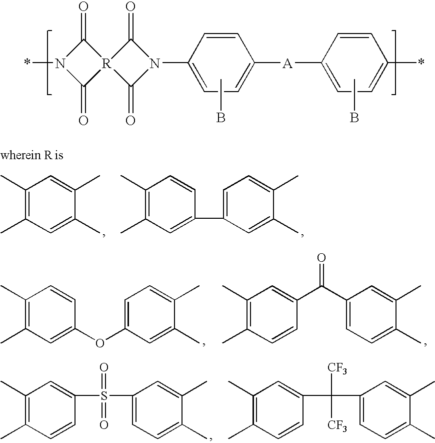
wherein A is —O, —S—, —CH₂—, C(CH₃)₂, or C(CF₃)₂ and the like; B is —H, —OH, or —NH₂.

Typically, the polyhedral oligomeric silsesquioxane usable in the present invention is represented by chemical formula (SiO_{1.5})ₙRₙ₋₁R′, wherein n=6, 8, 10, 12, R is alkyl having 1 to 6 carbon atoms or phenyl, R₁ is —R₁—B; R₁ is alkyl having 1 to 6 carbon atoms or phenyl, and B is selected from group at least consisting —NH₂, —OH, —Cl, —Br, —I, or other derivatives having diamine group (2NH₂), for example, reactive functional groups as —R₁—N(—Ar—NH₂)₂, —R₁—O—Ar—CH(—Ar—NH₂)₂ and the like.

Comparing to conventional technology used for reducing dielectric constant of polyimide mentioned above, the present composites are modified reactive inorganic oligomers, which are formed through bonding to polyimide substrate by way of covalent bonds regularly and homogeneously; the advantages of the present composites at least include effectively improving the distribution of polyhedral oligomeric silsesquioxane in polyimide through the covalent bonding of modified polyhedral oligomeric silsesquioxane and polyimide; and the consistency of pores of polyhedral oligomeric silsesquioxane, with pore size ranging between 0.3 and 0.4 nanometer. As to the synthesis of said material, the starting materials of polyhedral oligomeric silsesquioxane usable in the present invention are readily available, which can be substituted by commercial grade products available from Hybrid Plastic Corp.; in addition, the present invention utilizes traditional polyimide synthesis process to directly react polyhedral oligomeric silsesquioxane, which has 2NH₂-reactive functional groups on the surface, with dianhydride to form said nanocomposites, therefore, the synthesis technology is well known.

Another object of the present invention is to provide a process to improve the distribution of inorganic molecular cluster in polyimide. Polyhedral oligomeric silsesquioxane/polyimide nanocomposites are a self-assembled system, in which polyhedral oligomeric silsesquioxane is distributed inside polyimide regularly, and POSS tethering onto different chains based on polyimide is automatically assembled by the van der Waals interactions between the alkyl or aromatic group such as but not limited to cyclopentyl group of POSS molecules; therefore, the self-assembled system formed by covalent bonding is capable of controlling the distribution of polyhedral oligomeric silsesquioxane inside polyimide effectively and homogeneously.

### BRIEF DESCRIPTION OF THE DRAWINGS

FIG. 1 is an X-ray diffractogram from the polyhedral oligomeric silsesquioxane and polyhedral oligomeric silsesquioxane/polyimide nanocomposite film of Examples 3; wherein (a) 6FDA-HAB, (b) 10 mole % Cl-POSS/6FDA-HAB, (c) 22 mole % Cl-POSS/6FDA-HAB, (d) 35 mole % Cl-POSS/6FDA-HAB, and (e) Cl-POSS.

FIG. 2 is an X-ray diffractogram from the polyhedral oligomeric silsesquioxane and polyhedral oligomeric silsesquioxane/polyimide nanocomposite film of Examples 4; wherein (a) PMDA-ODA, (b) 5 mole % 2NH₂-POSS/PMDA-ODA, (c) 10 mole % 2NH₂-POSS/PMDA-ODA, (d) 16 mole % 2NH₂-POSS/PMDA-ODA, and (e) 2NH₂-POSS.

FIG. 3 is a diagram showing tethering cage shape POSS on polyimide main chains and exhibiting self-assembled architecture; wherein the size of pores contained in cage shape POSS is 0.3 to 0.4 nanometer.

FIGS. 4 and 5 are sectional field emission scanning electronic microscopy and transmission electronic microscopy images from Example 3.

FIG. 6 is a transmission electronic microscopy image of Example 4.

### DETAILED DESCRIPTION OF THE INVENTION

The dielectric constant of the present polyhedral oligomeric silsesquioxane/polyimide (PMDA-ODA) nanocomposites is lower than that of general pure polyimide (PMDA-ODA) (for example, as the testing results shown in Examples and Control Examples of the present invention, in which a best result is obtained reducing from 3.26 to 2.32). The reasons to reduce dielectric constant include factors as: the nanopores contained in polyhedral oligomeric silsesquioxane are homogeneously distributed in polyimide; when polyhedral oligomeric silsesquioxane connects to ends or side chains of polyimide and forms self-assembled architecture, the distance between polyimide molecular chains is largely increased so that free volume is increased; and the polarization degree of polyhedral oligomeric silsesquioxane is lower than that of polyimide.

As mentioned herein, “self-assembled” acts like what hydrophilicity and hydrophobicity do in synthesizing cell membranes with proteins and molecules in biochemistry; it is necessary for said molecules to have hydrophilic and hydrophobic areas, and these molecules utilize said hydrophilic and hydrophobic areas to automatically form more complicated and biologically useful architecture after being put into water; while this process is called “self-assembled”, a difference is that the synthesis of the present composites utilizes non-polar area in the cage architecture of polyhedral oligomeric silsesquioxane.

An opposite term is “positional assembly”, in contrast to “self-assembled”, which highly requires engineers to dispose to control the assembly of each independent atom or molecule; relative to “self-assembled”, it is a passive but less complicated chemical synthesis process.

In one embodiment of the present invention, when a small amount of polyhedral oligomeric silsesquioxane is added, Young's modulus and maximum stress of the nanocomposite film are almost the same as pure polyimide; however, as the added amount of polyhedral oligomeric silsesquioxane is increased, Young's modulus, maximum stress, and maximum elongation of the nanocomposite film reduce to a certain degree, which is caused by that the interaction between molecular chains of the nanocomposite film are weakened by the effects from polyhedral oligomeric silsesquioxane (as its free volume increases). As to other similar low dielectric materials, for example, the pore type siloxane (HSSQ, MSSQ) prepared by sol-gel process, the dielectric constant is lowered by the presence of other low dielectric materials, so that the low dielectric property derives from the loose structure; however, most portion of said loose structure is not capable of forming self-standing free film, and it is not able to be measured mechanically (mechanical properties are very weak).

Further, in the present composites, elastic modulus, E₁, decreases as the added amount of polyhedral oligomeric silsesquioxane is increased, which is similar to Young's modulus in the mechanical stretching test results; however, hardness, H, of the nanocomposites is not significantly correlated to the addition of polyhedral oligomeric silsesquioxane, which is different from the case of general low dielectric materials in which hardness is lowered because of loose structure, for example, the hardness value of porous silica dioxide is about 1/7 of that of general silica dioxide; it may be due to the covalent bonding between polyhedral oligomeric silsesquioxane and polyimide, and the nanometer dimensional distribution inside polyimide, so that the hardness value of the materials is not effected.

As to the thermal properties and hydroscopicity of the present nanocomposites, the thermal properties are reduced with the increased added amount of polyhedral oligomeric silsesquioxane, which is due to the inferior thermal properties of the cyclopentyl groups attached to the vertices of polyhedral oligomeric silsesquioxane comparing to polyimide. In addition, when polyhedral oligomeric silsesquioxane is added to low content, the hydroscopicity is higher than pure polyimide (PMDA-ODA), and while added to high content, the hydroscopicity is lower than pure polyimide (PMDA-ODA); it may be effected generally by two factors, the addition of polyhedral oligomeric silsesquioxane makes loose polyimide molecular chains to enable moisture to be easily adsorbed into materials, and the hydroscopicity of polyhedral oligomeric silsesquioxane is lower than that of polyimide.

Another object of the present invention is to provide a reactive polyhedral oligomeric silsesquioxane and the synthesis thereof. Typically, the polyhedral oligomeric silsesquioxane usable in the present invention is represented by chemical formula (SiO_{1.5})ₙRₙ₋₁R′, wherein n=6, 8, 10, 12, R is alkyl having 1 to 6 carbon atoms or phenyl, R′ is —R₁—B; R₁ is alkyl having 1 to 6 carbon atoms or phenyl, and B is selected from group at least consisting —NH₂, —OH, —Cl, —Br, —I, or other derivatives having diamine group (2NH₂), for example, reactive functional groups as —R₁—N(—Ar—NH₂)₂, —R₁—O—Ar—CH(—Ar—NH₂)₂ and the like. By example of Cl as reactive functional groups, the preparation process includes: trichloro(4-(choloromethyl)-phenyl)silane, cyclohexyltrisilanol-POSS, and triethylamine are put into a bottle containing dry THF solvent; thereafter, the content is agitated under the condition of flowing nitrogen to react about 2 hours, and then filtered to remove HNEt₃Cl. Finally, the filtrate is dropped into acetonitrile solution to give precipitate, and polyhedral oligomeric silsesquioxane with Cl on surface as reactive functional groups is obtained after filtering and drying said precipitate. If NH₂ group is used as reactive functional group, then distinct from Cl, NH₂ group is selective for more reactive species than Cl, especially for anhydrides.

### DESCRIPTION OF PREFERRED EMBODIMENTS

The present invention discloses the following examples but should not be limited thereto.

### EXAMPLE 1

### The Preparation of Polyhedral Oligomeric Silsesquioxane with Cl Reactive Functional Groups on Surface

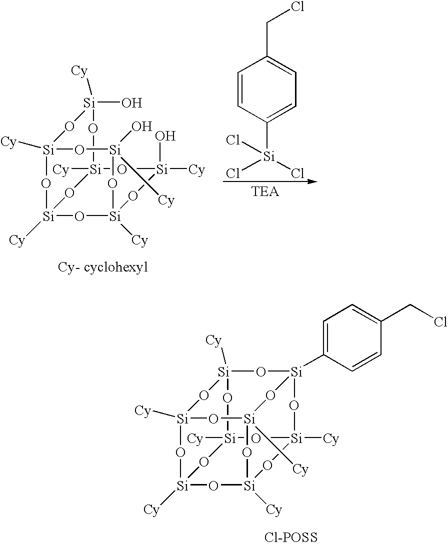 [0031] 1. Trichloro(4-(choloromethyl)-phenyl)silane (1.00 ml; 5.61 mmol), cyclohexyltrisilanol-POSS (5.00 g; 2.11 mmol), and triethylamine (2.2 ml; 15.41 mmol) were put into a three-necked bottle containing 30.0 ml dry THF solvent.
2. Thereafter, the content was agitated under the condition of flowing nitrogen to react about 2 hours, and then filtered to remove HNEt₃Cl.
3. The filtrate was dropped into acetonitrile solution to give precipitate, and 4.61 g (solid content is 80%) of polyhedral oligomeric silsesquioxane with Cl reactive functional groups on surface was obtained after filtering and drying said precipitate.

### EXAMPLE 2

### The Preparation of Polyhedral Oligomeric Silsesquioxane with 2NH₂ Reactive Functional Groups on Surface

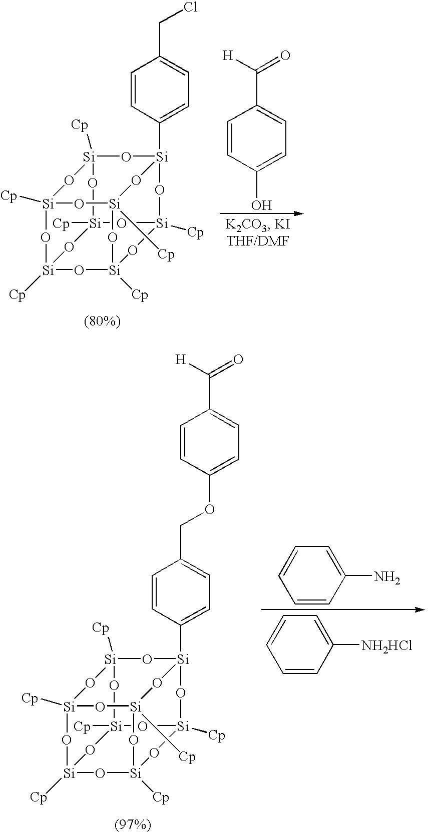 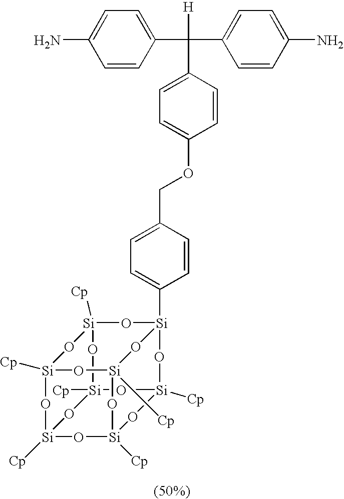 [0035] 1. 4-Hydroxybenzaldehyde (0.14 g; 1.06 mmol) and K₂CO₃ (0.32 g; 0.98 mmol) were put into a three-necked bottle containing dry DMF (10.0 ml) solvent.
2. Thereafter, the content was heated to 80° C. under the condition of flowing nitrogen and agitated to react about 1 hour, and then Cl-POSS (1.00 g; 0.80 mmol) and NaI (0.14 g; 0.98 mmol) solubilized in 10 ml dry THF were added into the three-necked bottle to react 4 hours.
3. The reaction solution was dropped into water, extracted 3 times with dichloromethane (3×15.0 ml), then the pale yellow powder resulting from concentration of organic layer was dried.
4. Aniline (3.14 g; 34.5 mmol), aniline hydrochloride (0.08 g; 0.59 mmol), and the yellow powder from step 3 (1.22 g; 10.0 mmol) were added into the three-necked bottle to solubilize with heat.
5. After the mixed solution was heated to 150° C. to react 1 hour, aniline was removed by distillation under reduced pressure.
6. Polyhedral oligomeric silsesquioxane with 2NH₂ reactive functional groups on surface (solid content is 50%) was separated by column chromatography.

### COMPARATIVE EXAMPLE 1

### The Synthesis of Polyamic Acid

1.0.0147 mole of 4,4′-oxydianiliane (ODA) was solubilized into 32.94 g of N,N-dimethylacetamide (DMAc) in a three-necked bottle with flowing nitrogen at room temperature, after ODA was solubilized completely, 0.015 mole of pyromellitic dianhydride (PMDA) was added in portions until PMDA was solubilized completely, the agitation was continued for 1 hour, and a viscous polyamide acid solution (solid content is 11˜16%) was formed.
2. By way of doctor blade coating, the polyamide acid solution mentioned above was applied on a glass plate to form a film, which was heated with an elevation rate of 2° C./min and was maintained 1 hour at 100, 150, 200, and 250° C., and 30 minutes at 300° C., respectively, so that the polyamide acid solution was closed-ring dehydrated, and a polyimide (PMDA-ODA) film was formed.

### EXAMPLE 3

### The Reaction Between Polyimide with Oh Groups and Polyhedral Oligomeric Silsesquioxane with Cl Functional Groups (Cl-POSS) to Synthesize Nanocomposites

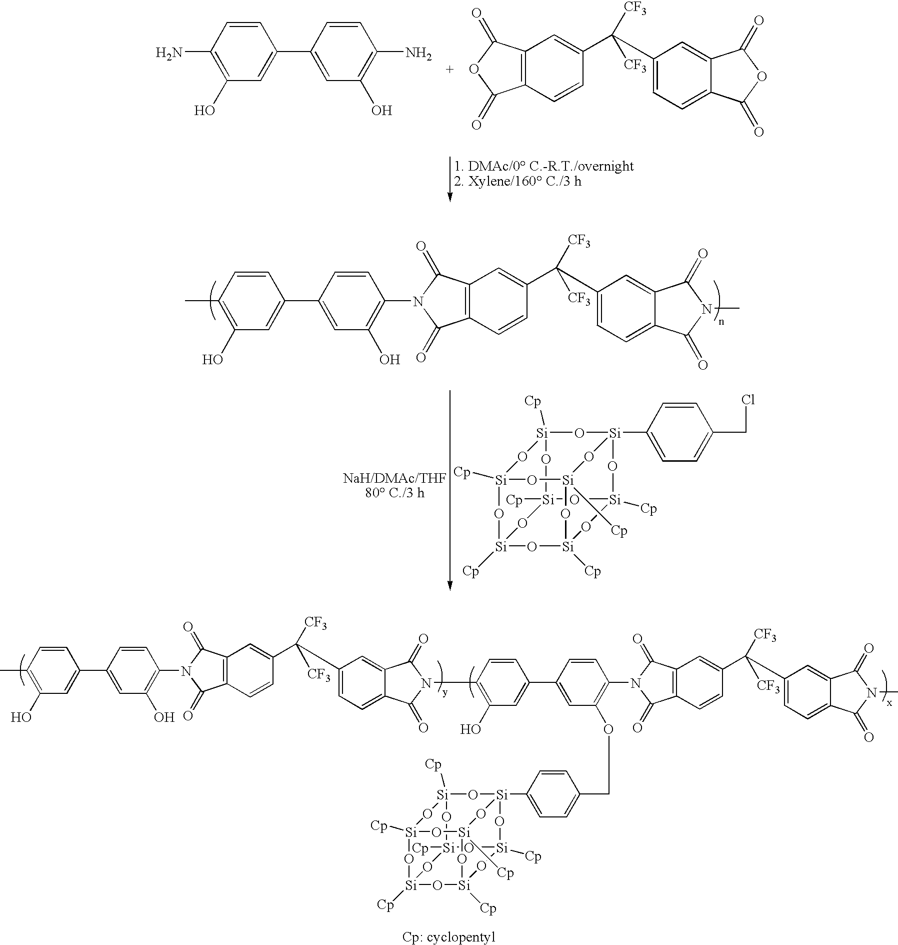 [0044] 1.18.50 mmoles of 3,3′-dihydroxy-4,4′-diaininobyphenyl (HAB) was solubilized into 90.83 g of N,N-dimethylacetamide (DMAc) in a three-necked bottle with flowing nitrogen at room temperature, after HAB was solubilized completely, 18.88 mmoles of 2,2′-bis(3,4-dicarboxyphenyl) hexafluoropropane dianhydride (6FDA) was added in portions until 6FDA was solubilized completely, the agitation was continued for 1 hour, and a viscous polyamide acid solution (solid content is 11˜16%) was formed.
2. Dry xylene (30 ml) was added into the three-necked bottle heated to 160° C. to proceed imidization for 3 hours.
3. The reaction solution was dropped into water to precipitate polyimide, and the polyimide was dried in vacuum oven for about 12 hours.
4. The polyimide (6FDA-HAB) was solubilized into DMAc/THF, various NaH ratios were added to react 0.5 hour at room temperature, and the polyhedral oligomeric silsesquioxane with Cl functional groups (Cl-POSS) of the same mole as NaH was added to react 2 hours at 70° C.
5. The reaction solution was dropped into water, and the precipitate was dried in vacuum oven.
6. By way of doctor blade coating, the polyhedral oligomeric silsesquioxane/polyamide acid nanocomposites mentioned above were applied on a glass plate to form a film, which was heated gradually and was maintained 1 hour at 100, 200, and 250° C., respectively, so that polyhedral oligomeric silsesquioxane/polyimide (6FDA-HAB) nanocomposite film was formed.

### EXAMPLE 4

### The Synthesis of Polyhedral Oligomeric Silsesquioxane with 2NH₂ Reactive Functional Groups On Surface (2NH₂-POSS)/Polyimide Nanocomposites

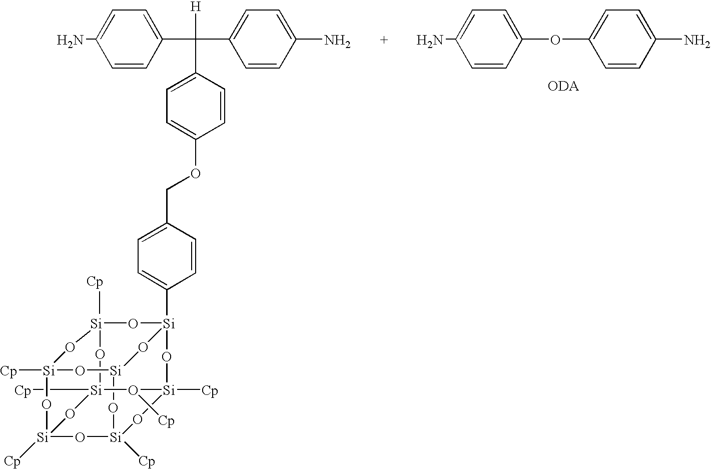 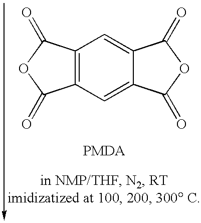 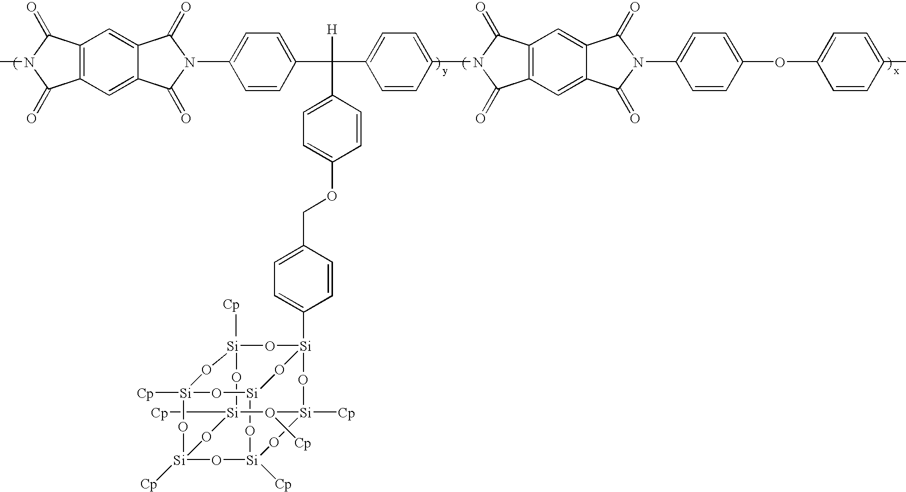 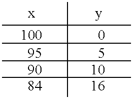 [0051] 1. Various molar ratios of ODA and 2NH₂-POSS (95/5, 90/10, 84/16) in a total amount of 0.0147 mole were added to NMP/THF (2/1) respectively in a three-necked bottle with flowing nitrogen at room temperature, after ODA was solubilized completely, 0.015 mole of PMDA was added in portions until PMDA was solubilized completely, the agitation was continued for 8 hour, and a viscous polyamide acid solution (solid content is 11%) was formed.
2. By way of doctor blade coating, the polyhedral oligomeric silsesquioxane/polyamide acid nanocomposites mentioned above was applied on a glass plate to form a film, which was heated with an elevation rate of 2° C./min and was maintained 1 hour at 100, 150, 200, and 250° C., and 30 minutes at 300° C., respectively, so that the polyhedral oligomeric silsesquioxane/polyamide acid mixture was closed-ring dehydrated, and a polyhedral oligomeric silsesquioxane/polyimide (PMDA-ODA) nanocomposite film was formed.
   Results

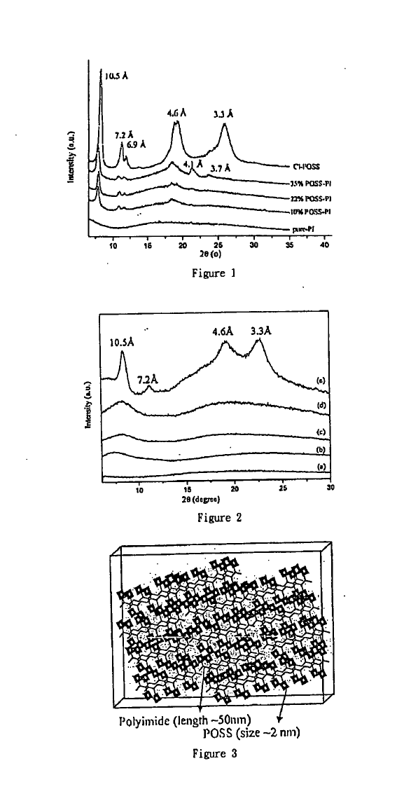

FIGS. 1 and 2 show X-ray diffractograms from the polyhedral oligomeric silsesquioxane and polyhedral oligomeric silsesquioxane/polyimide nanocomposite film of Examples 3 and 4. As can be seen from the figures, the polyhedral oligomeric silsesquioxane is of molecule size of about 1.2 nm, and exhibits crystalline structure. In addition, the polyhedral oligomeric silsesquioxane in polyhedral oligomeric silsesquioxane/polyimide nanocomposite film still exhibits crystalline structure, and this structure has pores with size of 0.3-0.4 nm.

FIG. 3 shows the architecture diagram of Examples 3 and 4, which exhibits self-assembled architecture, contains cage shape POSS with pore size of about 0.3 to 0.4 nanometer, and cage shape POSS on different polyimide main chains with crystalline structure formed of polar areas.

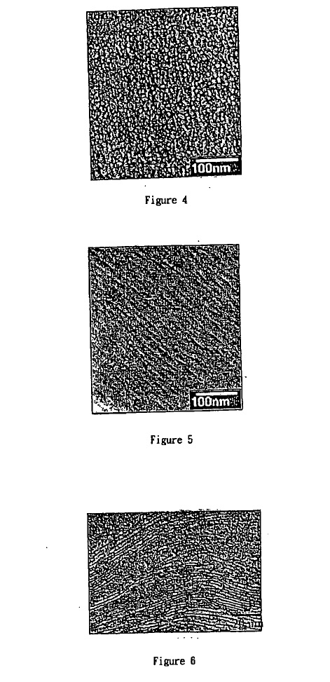

FIGS. 4 and 5 are sectional field emission scanning electronic microscopy and transmission electronic microscopy images from Example 3; as can be found in FIG. 4, particles with size of 10 nm are homogeneously distributed in polyimide with a little regularity, and as can be found in FIG. 5, in the whole distribution of polyhedral oligomeric silsesquioxane, the darker part of the image in the figure is caused by polyhedral oligomeric silsesquioxane; and from the figure it can be known that the polyhedral oligomeric silsesquioxane/polyimide nanocomposites are a self-assembled system, however, due to synthesis process, it is necessary to precipitate nanocomposites after formed to remove by-products, and it is also necessary to solubilize and form a film again, so that the focusing particles are larger (about 10 nm).

FIG. 6 is a transmission electronic microscopy image of Example 4; as can be found in the figure, in the whole distribution of polyhedral oligomeric silsesquioxane, the black lines (with width of 2 nm) of the image in the figure are caused by polyhedral oligomeric silsesquioxane, and are distributed in polyimide regularly and homogeneously. Polyhedral oligomeric silsesquioxane/polyimide (PMDA-ODA) nanocomposites are a self-assembled system, so that nanocomposites formed by covalent bonding can be distributed in polyimide in a way of effectively controlling polyhedral oligomeric silsesquioxane.

Table 1 is a list of dielectric constants for Comparative Example 1, and Examples 3 and 4. In Example 3, the dielectric constant of nanocomposites decreases as the molar amount of polyhedral oligomeric silsesquioxane increases. In Example 4, the dielectric constants of polyhedral oligomeric silsesquioxane/polyimide (PMDA-ODA) nanocomposites with different composition are lower than that of pure polyimide (PMDA-ODA) from Comparative Example 1.

Table 2 is the analytical data of mechanical stretching properties from polyimide (PMDA-ODA) of Comparative Example 1 and polyhedral oligomeric silsesquioxane/polyimide nanocomposites of Example 3 and 4; when a small amount of polyhedral oligomeric silsesquioxane is added, Young's modulus and maximum stress of the nanocomposite film are almost the same as pure polyimide; however, as the added proportion of polyhedral oligomeric silsesquioxane is increased, Young's modulus, maximum stress, and maximum elongation of the nanocomposite film reduce to a certain degree, which is caused by that the interaction between molecular chains of the nanocomposite film are weakened by the effects from polyhedral oligomeric silsesquioxane (as its free volume increases). Further, comparing to other low dielectric materials, for example, the pore type siloxane (HSSQ, MSSQ) prepared by sol-gel process, which use loose structure in order to reduce the dielectric constant, most of them are not capable of completing the measurement of mechanical stretching properties.

Table 3 is the analytical result of surface recess hardness test from polyhedral oligomeric silsesquioxane/polyimide (PMDA-ODA) nanocomposites of Example 3 and 4. The equivalent reduced elastic modulus, E₁, decreases as the added amount of polyhedral oligomeric silsesquioxane is increased, which is similar to Young's modulus in the mechanical stretching test results; however, hardness, H, of the nanocomposites is not significantly changed due to the addition of polyhedral oligomeric silsesquioxane, which is different from the case of general low dielectric materials in which hardness is lowered because of loose structure, for example, the hardness value of porous silica dioxide is about 1/7 of that of general silica dioxide; it may be due to the covalent bonding between polyhedral oligomeric silsesquioxane and polyimide, and the nanometer dimensional distribution inside polyimide, so that the hardness value of the materials is not effected.

Table 4 is thermal properties and hydroscopicity measurement from polyhedral oligomeric silsesquioxane/polyimide (PMDA-ODA) nanocomposites of Example 3 and 4, the thermal properties decrease as the added amount of polyhedral oligomeric silsesquioxane is increased, which is due to the inferior thermal properties of cyclopentyl groups attached to the vertices of polyhedral oligomeric silsesquioxane comparing to polyimide. In addition, it can be found from the table, when polyhedral oligomeric silsesquioxane is added to low content, the hydroscopicity is higher than polyimide (PMDA-ODA), and while added to high content, the hydroscopicity is lower than polyimide (PMDA-ODA); it may be effected generally by two factors: first, the addition of polyhedral oligomeric silsesquioxane makes loose polyimide molecular chains to enable moisture to be easily adsorbed into materials; second, the hydroscopicity of polyhedral oligomeric silsesquioxane is lower than that of polyimide. Since low added amount greatly effects the activity of polyimide molecular chains (as can be known from the difference between glass transition temperatures (Tg) of nanocomposites), the hydroscopicity increases when the first factor effects more significantly than the second does, and the hydroscopicity decreases when the added amount is increased and the second factor effects more significantly than the first does.

TABLE 1
Dielectric constants of polyhedral oligomeric silsesquioxane/polyimide
(PMDA-ODA) nanocomposites

| | Mol % of POSS in | Dielectric |
|---|---|---|
| Example 3 | 0 | 3.35 ± 0.16 |
| Example 3 | 10 | 2.83 ± 0.04 |
| Example 3 | 22 | 2.67 ± 0.07 |
| Example 3 | 35 | 2.40 ± 0.04 |
| Comparative | 0 | 3.26 ± 0.09 |
| Example 4 | 5 | 2.86 ± 0.04 |
| Example 4 | 10 | 2.57 ± 0.08 |
| Example 4 | 16 | 2.32 ± 0.05 |

TABLE 2
Analysis of Mechenical properties of polyhedral oligomeric
silsesquioxane/polyimide (PMDA-ODA) nanocomposites

| | mol % of | wt % of POSS | Young's | Elongation | Maximum |
|---|---|---|---|---|---|
| | POSS in | in polyimide | modulus | at break | stress |
| | polyimide | (%) | (GPa) | (%) | (MPa) |
| Comparative | 0 | 0 | 1.86 ± 0.08 | 5 ± 1 | 59.2 ± 7.7 |
| Example 3 | | | | | |
| Example 3 | 10 | 14.3 | 1.85 ± 0.09 | 4 ± 1 | 45.1 ± 5.1 |
| Example 3 | 22 | 26.5 | 1.20 ± 0.02 | 3 ± 1 | 22.3 ± 4.9 |
| Example 3 | 35 | 36.7 | 0.61 ± 0.07 | 2 ± 1 | 11.2 ± 3.9 |
| Comparative | 0 | 0 | 1.60 ± 0.07 | 6 ± 1 | 50.9 ± 1.2 |
| Example 1 | | | | | |
| Example 4 | 5 | 14.2 | 1.58 ± 0.08 | 5 ± 1 | 48.9 ± 5.1 |
| Example 4 | 10 | 26.6 | 1.43 ± 0.07 | 4 ± 1 | 46.4 ± 7.9 |
| Example 4 | 16 | 39.4 | 1.25 ± 0.04 | 2 ± 1 | 20.4 ± 1.1 |

TABLE 3
Surface recess hardness test analysis of polyhedral oligomeric
silsesquioxane/polyimide (PMDA-ODA) nanocomposites

| | mol % of | Equivalent | Surface | Maximum |
|---|---|---|---|---|
| | POSS in | elastic modulus | hardness | dislocation |
| | polyimide | (GPa) | (GPa) | (nm) |
| Comparative | 0 | 1.86 ± 0.08 | 0.15 ± 0.01 | — |
| Example 1 | | | | |
| Example 3 | 10 | 1.85 ± 0.09 | 0.11 ± 0.02 | — |
| Example 3 | 22 | 1.20 ± 0.02 | 0.07 ± 0.01 | — |
| Example 3 | 35 | 0.61 ± 0.07 | 0.06 ± 0.02 | — |
| Comparative | 0 | 4.4 ± 0.1 | 0.23 ± 0.01 | 361.3 ± 4.3 |
| Example 1 | | | | |
| Example 3 | 5 | 4.3 ± 0.1 | 0.23 ± 0.02 | 363.4 ± 3.5 |
| Example 3 | 10 | 4.2 ± 0.1 | 0.22 ± 0.01 | 370.0 ± 5.4 |
| Example 3 | 16 | 4.0 ± 0.1 | 0.21 ± 0.02 | 378.9 ± 3.9 |

TABLE 4
Thermal properties and hydroscopicity of polyhedral oligomeric
silsesquioxane/polyimide (PMDA-ODA) nanocomposites

| | mol % of | | | |
|---|---|---|---|---|
| | POSS in | Td (□) at 5 | | Hydroscopicity |
| | polyimide | wt % loss | Tg (□) | (%) |
| Comparative | 0 | 430.2 | 359.3 | — |
| Example 1 | | | | |
| Example 3 | 10 | 415.1 | 355.1 | — |
| Example 3 | 22 | 407.9 | 350.5 | — |
| Example 3 | 35 | 405.7 | 337.6 | — |
| Comparative | 0 | 604.6 | 350.7 | 1.8 |
| Example 1 | | | | |
| Example 4 | 5 | 583.7 | 316.6 | 2.0 |
| Example 4 | 10 | 552.4 | 308.1 | 2.3 |
| Example 4 | 16 | 534.5 | 303.9 | 1.4 |

What is claimed is:

1. A nanocomposite, wherein said composite is formed of modified polyhedral oligomeric silsesquioxane (POSS) and polyimide through covalent bonding, and are a self-assembled system with low dielectric constant and certain mechanical properties.

2. The nanocomposite according to claim 1, wherein the polyhedral oligomeric silsesquioxane is of reactive functional group, which is typically represented by chemical formula (SiO_{1.5})ₙRₙ₋₁R′, wherein n=6, 8, 10, 12, R is alkyl having 1 to 6 carbon atoms or phenyl, R′ is —R₁—B; R₁ is alkyl having 1 to 6 carbon atoms or phenyl, and B is selected from group at least consisting —NH₂, —OH, —Cl, —Br, —I, or other derivatives having diamine group (2NH₂), for example, reactive functional groups as —R₁—N(—Ar—NH₂)₂, —R₁ —O—Ar—CH(—Ar—NH₂)₂ and the like.

3. The nanocomposite according to claim 1, wherein the polyimide typically has polymerization units represented by following formula: 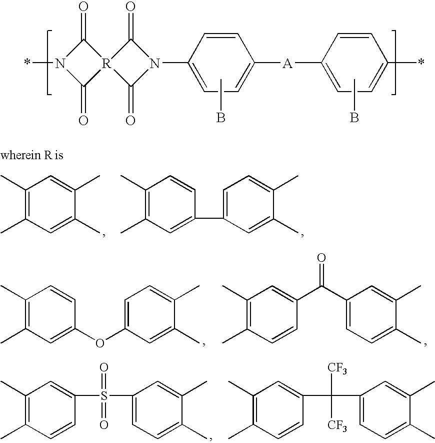
wherein A is —O—, —S—, —CH₂—, C(CH₃)₂, or C(CF₃)₂ and the like; B is —H, —OH, or —NH₂.

4. The nanocomposite according to claim 1, wherein the dielectric constant of said composite is reduced to 2.3.

5. A process for synthesizing polyhedral oligomeric silsesquioxane/polyimide nanocomposites, wherein porous type inorganic oxide oligomers are formed, and then are reacted with dianhydride, or directly through reacting with synthesized polyimide, which is characterized in that POSS tethering nanopores is covalently bonded to side chains of polyimide.

6. The process according to claim 5, wherein the polyhedral oligomeric silsesquioxane is of reactive functional group, which is typically represented by chemical formula (SiO_{10.5})ₙRₙ₋₁R′, wherein n=6, 8, 10, 12, R is alkyl having 1 to 6 carbon atoms or phenyl, R′ is —R₁—B; R₁ is alkyl having 1 to 6 carbon atoms or phenyl, and B is selected from group at least consisting —NH₂, —OH, —Cl, —Br, —I, or other derivatives having diamine group (2NH₂), for example, reactive functional groups as —R₁—N(—Ar—NH₂)₂, —R₁ —O—Ar—CH(—Ar—NH₂)₂ and the like.

7. The process according to claim 5, wherein the polyimide typically has polymerization units represented by following formula: 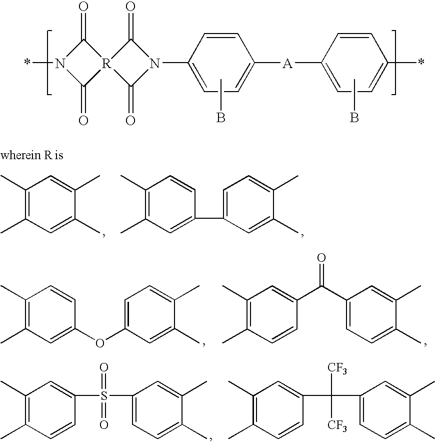
wherein A is —O—, —S—, —CH₂—, C(CH₃)₂, or C(CF₃)₂ and the like; B is —H, —OH, or —NH₂.

8. A process for lowering dielectric constant of polyimide, wherein porous type inorganic oxide oligomers are formed, and then are reacted with dianhydride, or directly through reacting with synthesized polyimide, which is characterized in that said inorganic oxide oligomers tethering nanopores connect to polyimide regularly with covalent bonds, and are a self-assembled system.

9. The process according to claim 8, which is applicable to the distribution or assembly of inorganic molecular cluster in polyimide.

10. A precursor for use in preparing polyhedral oligomeric silsesquioxane, wherein said precursor is typically represented by chemical formula (SiO_{1.5})ₙRₙ₋₁R′, wherein n=6, 8, 10, 12, R is alkyl having 1 to 6 carbon atoms or phenyl, R′ is —R₁—B; R₁ is alkyl having 1 to 6 carbon atoms or phenyl, and B is selected from group at least consisting —NH₂, —OH, —Cl, —Br, —I, or other derivatives having diamine group (2NH₂), for example, reactive functional groups as —R₁—N(—Ar—NH₂)₂, —R₁ —O—Ar—CH(—Ar—NH₂)₂ and the like.
